(19) United States
(12) Patent Application Publication
(10) Pub. No.: US 2002/0111876 A1
(43) Pub. Date: Aug. 15, 2002

(54) Transaction aggregation system and method

(76) Inventors: Panduranga R. Rudraraju, Scotts Valley, CA (US); Atul Narkhede, Srinagar Colony (IN); Abhinandan Prateek, Hyderabad AP (IN); Madhura Nirkhe, Hyderabad (IN); Chandrashekhar Shetty, Calcutta (IN)

Correspondence Address: MORRISON & FOERSTER LLP, 425 MARKET STREET, SAN FRANCISCO, CA, 94105-2482, US

(21) Appl. No.: 09/861,368

(22) Filed: May 17, 2001

Related U.S. Application Data
(60) Provisional application No. 60/267,779, filed on Feb. 9, 2001.

(51) Int. Cl. G06F 17/60; G06F 15/16

(52) U.S. Cl. 705/26; 709/206

(57) ABSTRACT

An aggregation system is configured to execute transactions between a customer and a merchant as transaction messages. The transaction aggregation system includes a user agent, multiple message schemas, a repository for storing the message schemas, and a transaction engine. The user agent converts a transaction request received from the customer into a first-transaction message. The transaction engine then receives and maps the first-transaction message into a second-transaction message using one of the message schemas. The transaction engine then transmits the second-transaction message to the merchant to execute the customer transaction.

### BACKGROUND OF THE INVENTION

1. Field of the Invention

The present invention relates to the general field of computers, telecommunications, and computer and Internet related systems. More specifically, the invention relates to a transaction aggregation system and method for facilitating various types of transactions between a customer and a merchant.

2. Description of Related Art

E-commerce can include various activities and/or transactions conducted between a customer and a merchant, such as buying a good and/or service, making a reservation, obtaining the status of an order, and the like. These activities and/or transactions can be conducted through any convenient electronic medium, such as through computer networks, telephone lines, wireless networks, optical networks, and the like. For e-commerce conducted through the Internet and the web, a customer typically conducts transactions directly with a merchant. For example, assume that a merchant sells books and that a customer wants to purchase a book from the merchant. Typically, the merchant sells books through their web site. As such, in order for a customer to purchase a book from the merchant, the customer needs to access the merchant's web site.

Additionally, E-commerce transactions between the customer and the merchant are typically conducted synchronously. For example, when the customer places an order with the merchant through their web site, the customer must remain logged on to the web site during the entire ordering process. Thus, synchronous transactions can consume a lot of time and require focused attention. Furthermore, if the connection between the customer and the merchant is interrupted during a synchronous transaction, the order is typically lost. This can result in lost revenues for the merchant and dissatisfaction for the customer.

Additionally, an increasing number of customers are accessing the Internet through smaller and more portable devices, such as wireless telephones, Personal Digital Assistant (PDAs), internet appliances, and the like. However, it can be more costly and difficult to maintain the connection between customer and merchant on these devices. Additionally, the limited display and user-interface capabilities of these devices, limit the amount of information that can be displayed and or entered through these devices. For example, at present, wireless telephones can be configured to provide Internet access. However, these web-enabled telephones typically have limited display capabilities and limited keyboards.

Furthermore, different merchants can require different procedures for conducting transactions with their web site. For example, assume that there are three merchants and that they all sell books. It is not uncommon for each merchant to provide a proprietary web site that has a purchasing process that differs from other merchants. As such, if customer wants to obtain goods and/or services from these merchants, customer typically logs onto the web site for each merchant and places an order with each merchant.

### SUMMARY OF THE INVENTION

The present invention relates to a transaction aggregation system which executes transactions between a customer and a merchant as transaction messages. In accordance with one aspect of the present invention, the transaction aggregation system includes a user agent, multiple message schemas, a repository for storing the message schemas, and a transaction engine. The user agent converts a transaction request received from the customer into a first-transaction message. The transaction engine then receives and maps the first-transaction message into a second-transaction message using one of the message schemas. The transaction engine then transmits the second-transaction message to the merchant to execute the customer transaction.

### BRIEF DESCRIPTION OF THE DRAWINGS

FIG. 1 is a block diagram of one embodiment of a transaction aggregation system;

FIG. 2 is a block diagram of another embodiment of a transaction aggregation system;

FIG. 3 is a graph depicting the processing of a transaction;

FIG. 4 is a graph depicting an example of an order-process flow;

FIG. 5 is one example of an order-process flow;

FIG. 6 is one example of an order message;

FIG. 7 is a block diagram depicting the mapping of the order message in FIG. 6 into multiple separate merchant-specific-order messages;

FIG. 8 is a block diagram of another embodiment of a transaction aggregation system;

FIG. 9 is another example of an order-process flow; and

FIG. 10 is a block diagram of another embodiment of a transaction aggregation system.

### DETAILED DESCRIPTION OF THE PREFERRED EMBODIMENT

In order to provide a more thorough understanding of the present invention, the following description sets forth numerous specific details, such as specific configurations, parameters, and the like. It should be recognized, however, that such description is not intended as a limitation on the scope of the present invention, but is instead provided to enable a more full and complete description of exemplary embodiments.

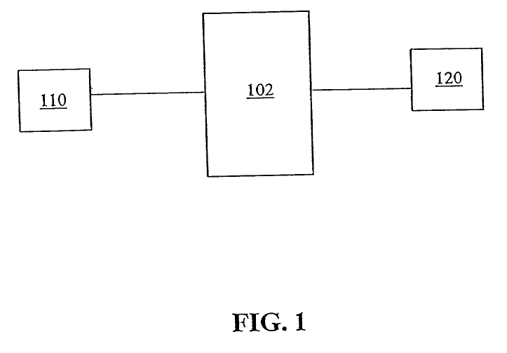

With reference to FIG. 1, a transaction-aggregation system 102 is depicted connecting a customer 110 and a merchant 120. As will be described in greater detail below, in accordance with one aspect of the present invention, transaction-aggregation system 102 is configured to facilitate electronic commerce (e-commerce) between customer 110 and merchant 120. It should be recognized, however, that transaction-aggregation system 102 can be configured to facilitate various types of transactions other than those that relate to e-commerce. In a preferred embodiment, the transaction-aggregation system 102 can run on a user workstation such as a Sun® Ultra5™ workstation. However, it should be noted that the transaction aggregation system 102 can also run on a general purpose PC.

As a preliminary matter, it should be recognized that customer 110 can include any party that is interested in obtaining a good and/or service, such as an individual consumer, a business, and the like. Merchant 120 can include any party that is interested in providing a good and/or service, such as an individual retailer, a business, and the like. Additionally, although one customer 110 and merchant 120 are depicted in FIG. 1, it should be recognized that transaction-aggregation system 102 can facilitate transactions between any number of customers 110 and merchants 120.

In accordance with one aspect of the present invention, transaction-aggregation system 102 can be configured to model transactions between customer 110 and merchant 120 as transaction messages. As will be described in greater detail below, transactions between customer 110 and merchant 120 can be modeled as messages exchanged between customer 110 and transaction-aggregation system 102, messages exchanged between transaction-aggregation system 102 and merchant 120, and messages exchanged within transaction-aggregation system 102. As such, as will be described in greater detail below, customer 110 can provide a more uniform, simpler, and convenient procedure for conducting transactions with any number of merchants 120.

As will be described in greater detail below, in one embodiment of the present invention, these transactions are modeled utilizing Extensible Markup Language (XML). As such, each transaction between customer 110 and merchant 120 can be modeled as an XML string (i.e., an XML message). For example, customer 110 can request an order from merchant 120. As will be described below, such an order transaction can be modeled as a series of XML messages exchanged between customer 110 and transaction-aggregation system 102, within transaction-aggregation system 102, and between transaction-aggregation system 102 and merchant 120. One advantage of utilizing XML is that the XML messages can be easily interchanged without requiring proprietary software. However, it should be recognized that the present invention can be implemented utilizing any convenient protocol or programming language.

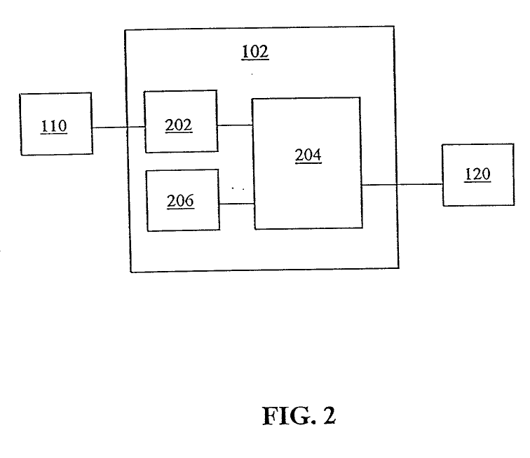

With reference now to FIG. 2, in one exemplary embodiment, transaction-aggregation system 102 includes a user agent 202 and a transaction engine 204. As described above, in the present embodiment, user agent 202 is configured to communicate with customer 110 through the Internet. More particularly, in one preferred embodiment, user agent 202 can include a web site with a Uniform Resource Locator (URL). As such, customer 110 can access user agent 202 through a browser. Additionally, customer 110 can access user agent 202 utilizing a variety of devices, such as a web-enabled cell phone, a Personal Digital Assistant (PDA), an Internet appliance, a laptop, a desktop, and the like. Furthermore, customer 110 can access user agent 202 through any number of intermediary web sites, portals, and the like. As noted earlier, it should be recognized, however, that transaction-aggregation system 102 can be configured to communicate with customer 102 through various types of devices utilizing various communication protocols.

With continued reference to FIG. 2, when customer 110 submits a transaction request, user agent 202 is configured to convert this request into an XML message. User agent 202 then transmits this XML message to transaction engine 204. As alluded to earlier, customer 110 can access user agent 202 utilizing a variety of devices and utilizing a variety of communication protocols. Accordingly, user agent 202 can be configured to convert requests in various protocols into XML messages. For example, if customer 110 accesses user agent 202 through a web browser, then user agent 202 can be configured to convert the request from customer 110 in HTML format into an XML message. Similarly, if customer 110 accesses user agent 202 through a web-enabled-wireless telephone (WAP browser), then user agent 202 can be configured to convert the request from customer 110 in WML format into an XML message.

As will be described in greater detail below, transaction engine 204 then processes the XML message to execute the transaction request with merchant 120. In this manner, customer 110 can request goods and/or services from any number of merchants 120 by interacting with user agent 202. Additionally, as will be described in greater detail below, transaction engine 204 can accommodate merchants 120 with varying requirements for conducting transactions while providing customer 110 with a more uniform interface.

For example, assume that customer 110 wants to order a good and/or service from merchant 120. Customer 110 can send an order request to user agent 202 to order the good and/or service from merchant 120. User agent 202 receives this order request from customer 110 and converts it into an XML message. User agent 202 then sends this XML message to transaction engine 204. As alluded to above, user agent 202 can provide customer 110 a single uniform order request. As also alluded to earlier and as will be described in greater detail below, transaction engine 204 can then process the uniform order request from customer 110 and execute the order with any number of merchants 120, regardless of the particular ordering process that a merchant 120 may require.

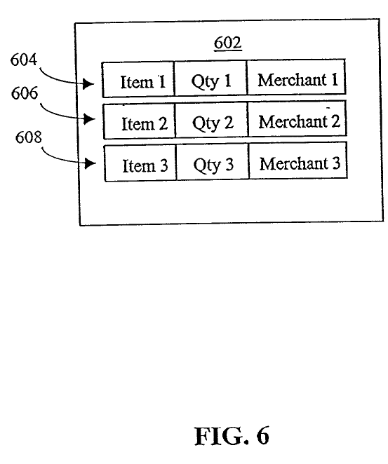

Additionally, multiple transactions can be requested utilizing a single transaction request. For example, with reference to FIG. 6, an order request 602 can include multiple orders 604, 606, and 608 that specify different items, quantities, and merchants.

Furthermore, with reference again to FIG. 2, after submitting a transaction request with user agent 202, customer 110 can disconnect from user agent 202. As such, customer 110 need not remain connected until the transaction is completed with merchant 120. As will be described in greater detail below, status on the transaction can be provided to customer 110 when customer 110 reconnects with user agent 202. It should be recognized that customer 110 need not reconnect utilizing the same device that may have been used to initiate the transaction.

Thus far, user agent 202 has been described as converting requests received from customer 110 into messages that are sent to transaction engine 204. It should be recognized, however, that user agent 202 can be configured to also convert messages received from transaction engine 204 into an appropriately formatted message for customer 110. For example, if customer 110 accesses user agent 202 through a web browser, then user agent 202 can be configured to convert the XML message received from transaction engine 204 into an HTML formatted message. Similarly, if customer 110 accesses user agent 202 through a web-enabled-wireless telephone (WAP browser), then user agent 202 can be configured to convert the XML message received from transaction engine 204 into a WML formatted message.

Furthermore, XML styles sheets (i.e., XSLs) can be utilized to customize the message for a particular customer 110. Accordingly, user agent 202 determines the type of device customer 110 is utilizing, such as a desktop computer, a web-enabled telephone, a PDA, and the like. It then determines the format to utilize, such as HTML, WML, XML, Voice XML, and the like. User agent 202 can then convert the XML message to any appropriate format for each customer 110.

In one preferred embodiment, user agent 202 can be implemented as a JAVA application server. However, it should be recognized that user agent 202 can be implemented as any number and type of application server.

As described above, the various transactions between customer 110 and transaction-aggregation system 102 can be modeled as transaction messages. More particularly, in the present embodiment, transactions are modeled as XML messages. Thus, as also described above, user agent 202 converts transaction requests received from customer 210 into XML messages. When these XML messages are received by transaction engine 204, they are verified with their appropriate XML schemas. As such, transaction-aggregation system 102 includes XML schemas that correspond to the various XML messages that can be utilized to model the various transaction requests from customer 110. In the present embodiment, these XML schemas are stored in a repository 206 that can be configured as a table, a database, and the like. Additionally, in the present embodiment, these XML schemas are located utilizing a Lightweight Directory Access Protocol (LDAP) system.

When user agent 202 converts a transaction request received from customer 110 into an XML message, it includes in the XML message a tag specifying the appropriate schema for that XML message. When the XML message is received by transaction engine 204, it reads the tag and retrieves the appropriate XML schema from repository 206. In this manner, the XML message can be verified to insure that it is well-formed and valid.

For example, assume that customer 110 has made an order request. Accordingly, user agent 202 converts the order request into an XML message that includes a tag specifying that an order schema corresponds to the XML message. As such, when transaction engine 204 reads the XML message, it retrieves the corresponding order schema from repository 206. It then confirms that the XML message is a well-formed and valid order message.

Having received and examined the transaction message, transaction engine 206 then processes the transaction message. In accordance with one aspect of the present invention, transaction engine 204 can be configured to queue transaction messages before processing them. Accordingly, as alluded to earlier, customer 110 can disconnect after sending a transaction request to user agent 202. When the transaction request is received by user agent 202, it can be converted into a transaction message and sent to transaction engine 204. The transaction message can then be queued in transaction engine 204 to be processed at a later time.

For example, if the transaction request involved communicating with merchant 120, there may be a delay before the transaction request can be executed by merchant 120. As such, rather than requiring that customer 110 remain connected and wait for merchant 120 to execute the transaction request, customer 110 can disconnect and transaction engine 204 can communicate with merchant 120 to have the request executed. In this manner, transaction-aggregation system 102 can facilitate asynchronous communication between customer 110 and merchant 120.

In accordance with another aspect of the present invention, transaction engine 204 can be configured to process transaction messages in accordance with conditions and processes set forth in a process flow. More particularly, in one embodiment of the present invention, the processing of a transaction can be modeled as a graph. Based on this graph, a process flow for the transaction can then be generated.

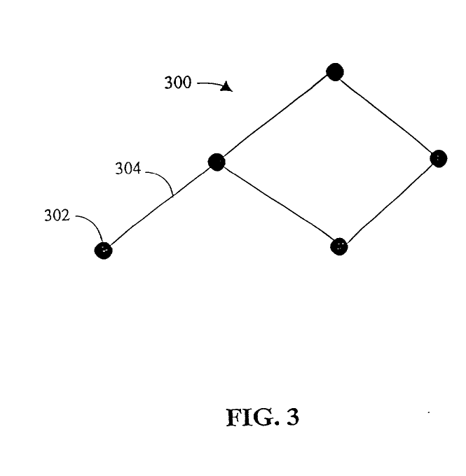

For example, with reference to FIG. 3, a graph 300 depicts the processing of a transaction. As depicted in FIG. 3, graph 300 includes nodes 302 and edges 304. Each node 302 of graph 300 represents a particular process to be performed in processing the transaction. Each edge can represent a condition that can be tested before performing the process set forth at a node 302.

As will be described below in greater detail with regard to an example, a process flow can be generated based on graph 300. More particularly, in the present embodiment, the process flow can be generated utilizing XML. In this manner, process flows can be generated to handle the processing of any transaction. However, it should be recognized that process flows can be generated without utilizing graph 300.

With reference again to FIG. 2, in the present embodiment, process flows can be stored in repository 206 utilizing an LDAP system. It should be recognized, however, that process flows can be stored in any convenient storage device utilizing any convenient storage system.

As an example, assume again that the XML message received was an order message. As described earlier, transaction engine 204 identifies the XML message received from user agent 202 as an order message and matches the order message with its corresponding order schema. Then, transaction engine 204 processes the order message in accordance with an order-process flow.

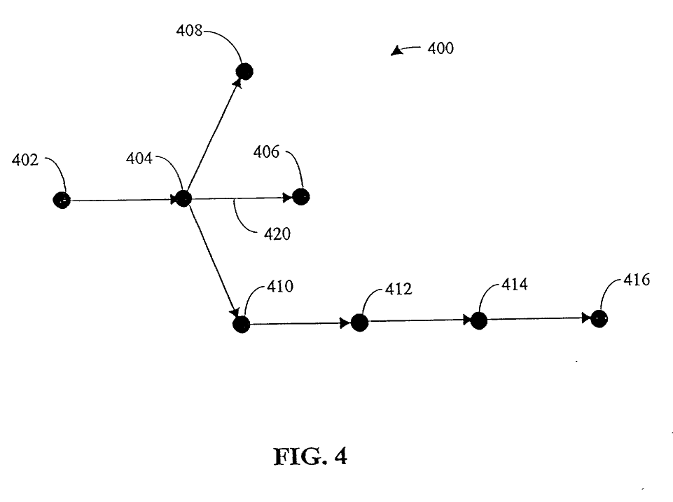

With reference to FIG. 4, a graph 400 is depicted of an example order-process flow. As depicted in FIG. 4, graph 4 includes nodes 402 through 416 that correspond to processing of an order message. More particularly, node 402 corresponds to an “Entry” process in which the order message is read. Node 404 corresponds to a “GenerateOrderID” process in which an identification is associated with the order message. Node 406 corresponds to a “reply” process in which a reply message is sent to customer 110 (FIG. 1). Node 408 corresponds to an “addOrderToTable” process in which an order is added to a table in transaction-aggregation system 102 (FIG. 1). Node 410 corresponds to a “fixMerchantConfig” process in which additional information relating to the merchant specified in the order message can be retrieved and added. Node 412 corresponds to a “placeOrderWithMerchant” process in which an order is placed with the appropriate merchant. Node 414 corresponds to a “updateOrderHistory” process in which the order history is updated for this order message. Node 416 corresponds to an “email” process in which an e-mail message is sent to customer 110 (FIG. 1).

With continued reference to FIG. 4, graph 400 also includes an edge 420 that connects node 404 and node 406. Edge 420 corresponds to a “/mesg/header/@schema=‘ebp.status’” condition, which is the same as a verification rule stating that the schema of the message is “ebp.status”. Node 406 is activated only if the condition in edge 420 is true. All of the remaining edges in graph 400 have conditions that are always true.

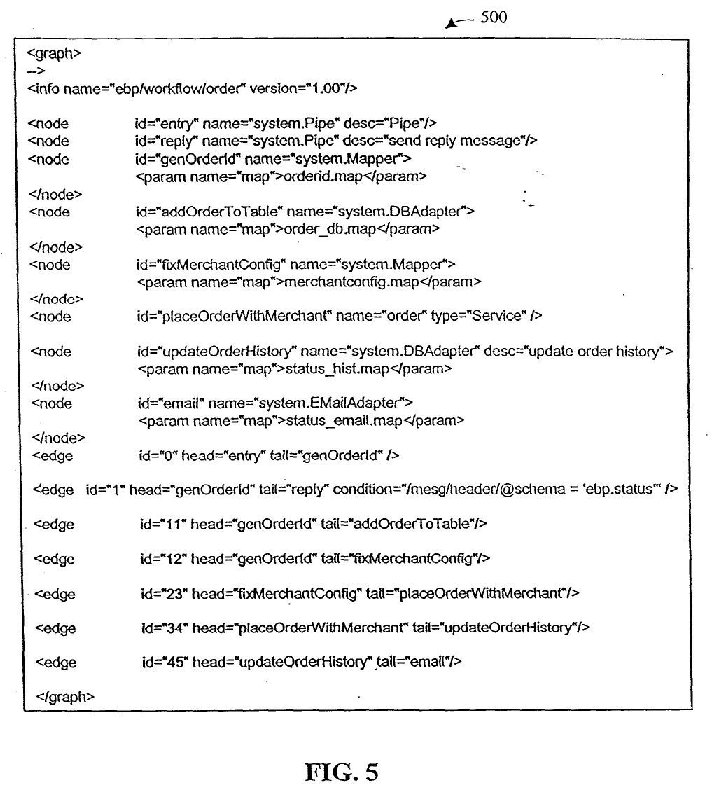

With reference now to FIG. 5, an order-process flow 500 is depicted. As described above, order-process flow 500 can be generated based on graph 400 shown in FIG. 4. In the present embodiment, as depicted in FIG. 5, order-process flow 500 is written in XML. It should be recognized, however, that order-process flow 500 can be written in any convenient programming language and/or protocol.

With reference again to FIG. 2, as described above, a transaction message can be processed by transaction engine 204 based on a process flow. In the present embodiment, as will be described in greater detail below, transaction engine 204 executes a transaction by taking transaction messages and transforming them into one or more messages. As such, a transaction can be modeled as processes passing transaction messages to each other with some input messages and some output messages. As will be described in greater detail below, in the present embodiment transaction messages can be transformed utilizing an appropriate mapping algorithm.

As also described earlier, in a preferred embodiment of the present invention, transaction messages are generated utilizing XML. As such, these XML messages have corresponding XML schemas. Thus, in the present preferred embodiment, schema-based mapping can be utilized to map one or more XML messages into one or more XML messages.

More particularly, XML schemas contain meta-information about their corresponding XML messages, such as data types, structures, relationships between tags and elements, occurrence counts, range of permissible values, and the like. Therefore, in schema-based mapping, the meta-information contained in the schemas can be utilized to transform one or more XML messages into one or more XML messages. As alluded to above, it should be recognized that multiple XML messages can be mapped into a single XML message. Alternatively a single XML message can be mapped into multiple XML messages.

As an example, assume again that the transaction message is an order message. In processing the order request, additional customer and merchant information can be gathered. More particularly, the order message can contain some customer and merchant information, such as their names, address, phone number, and the like. However, additional information relating to existing customers and merchants can be available on transaction-aggregation system 102. Alternatively, additional information can be obtained directly from customer 110 or merchant 120.

Utilizing the mapping process describe earlier, a merchant-specific-order message can be generated based on the original order message and the customer and merchant information retrieved from transaction-aggregation system 102. As alluded to earlier, a single order message can be mapped into multiple merchant-specific-order messages. Alternatively, multiple order messages can be mapped into a single merchant-specific order.

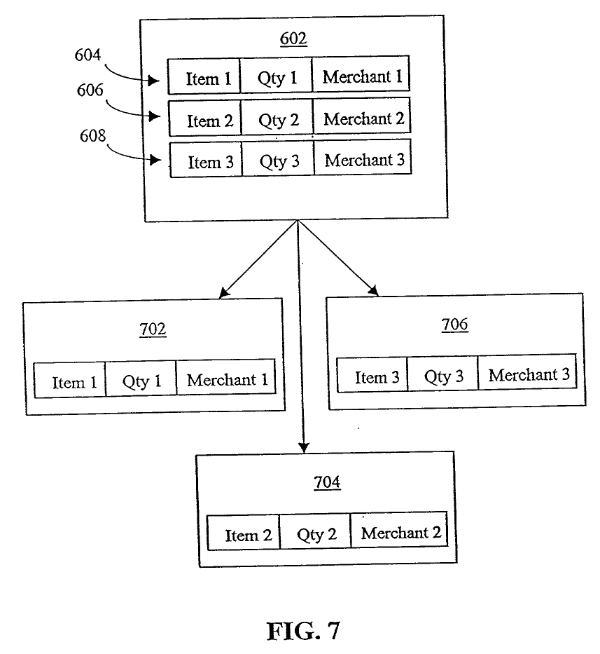

For example, with reference again to FIG. 6, order message 602 can include multiple orders 604, 606, and 608 that include different items, quantities, and merchants. As such, with reference now to FIG. 7, utilizing the mapping process described earlier, order message 602 can be mapped into three separate merchant-specific-order messages 702, 704, and 706.

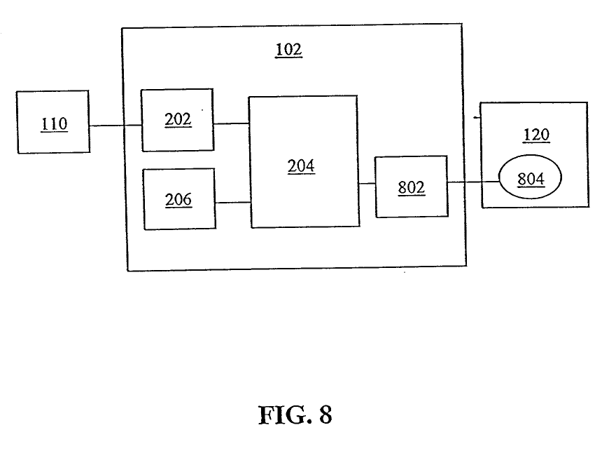

With reference now to FIG. 8, as described earlier, transaction engine 204 processes transaction messages by transforming one or more transaction messages into one or more different transaction messages. In some instances, however, transaction engine 204 may need to communicate with a device and/or system that does not directly accept transaction messages. As such, transaction-aggregation system 102 includes one or more process adapters 802.

In accordance with one aspect of the present invention, process adapter 802 can be configured to communicate with transaction engine 204 utilizing transaction messages and communicate with devices and/or systems that do not accept transaction messages. Additionally, a process adapter 802 can be utilized as part of any process flow to execute any transaction. As such, process adapter 802 need not be specific to one specific transaction.

For example, in a web-based transaction, process adapter 802 can be configured as an HTTP adapter 802. In accordance with one aspect of the present invention, HTTP adapter 802 simulates a browser to interact with web site 804, which is associated with merchant 120. As such, in response to transaction messages from transaction engine 204, HTTP adapter 802 can interact with web site 804. More particularly, as will be described in greater detail below, HTTP adapter 802 utilizes any convenient XML query process, such as XQL, to get data from and put data to web site 804.

As an example, assume again that the transaction request from customer 110 is an order request. Also assume that the order request contained multiple orders to multiple merchants as depicted in FIG. 6. As described earlier, these multiple orders to multiple merchants are mapped into multiple merchant-specific-order messages utilizing the mapping process described above in accordance with a process flow, as also described above. Now assume that order 702 (FIG. 7) is to be executed. Assume that order 702 (FIG. 7) is an order for a good and/or service from merchant 120 and that web site 804 belongs to merchant 120. As such, the order-process flow includes a process to retrieve an order-process flow specific to merchant 120.

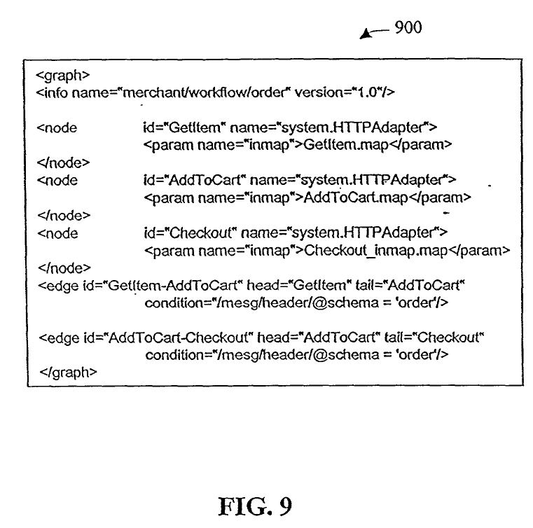

Assume now that to execute an order at web site 804, web site 804 requires that a user login, fill a cart with an item, and then check-out the cart. As such, with reference to FIG. 9, an order-process flow 900 specific to a particular merchant is depicted. In the present example, assume that order-process flow 900 includes a login process, a fill-cart process, and a check-out-cart process.

As such, with reference again to FIG. 8, to execute the order request, transaction engine 204 initiates HTTP adapter 802 to interact with web site 804. As alluded to earlier, HTTP adapter 802 can be configured to act as a browser to interact with website 804. Based on order 702 (FIG. 7), utilizing the mapping process described above, a new message is generated that includes the login name of customer 110. This message is utilized by HTTP adapter 802 to login to web site 804. If the login is successful, then HTTP adapter 802 returns a message indicating that the login was successful. Then, based on order 702 (FIG. 7), another message is generated that includes the item and quantity information. This message is then utilized by HTTP adapter 802 to fill the cart at web site 804. When this process is completed, based on order 702 (FIG. 7), still another message is generated that includes the payment and shipping information. This message is then utilized by HTTP adapter 802 to check-out the cart from web site 804. When the order is completed, then a message can be sent to customer 110 to indicate that their order has been fulfilled.

Additionally, as described with regard to an earlier example, transaction-aggregation system 102 can be configured to send an e-mail message to customer 110. For example, with reference to FIG. 4, as described earlier, node 416 corresponds to sending an e-mail message to customer 110 noting that their order request has been executed. With reference again to FIG. 8, in accordance with one aspect of the present invention, process adapter 802 can be configured as an e-mail adapter 802. Thus, in response to a transaction message from transaction engine 204, e-mail adapter 802 can generate an e-mail message to customer 110.

Although, process adapter 802 has been described as an HTTP adapter and an e-mail adapter, it should be recognized that process adapter 802 can be configured to communicate with devices and/or systems utilizing any convenient protocol. For example, process adapter 802 can be configured to access a database based on transaction message from transaction engine 204.

Furthermore, in accordance with one aspect of the present invention, process adapter 802 can be configured to be transaction independent, meaning that any particular process adapter 802 can be utilized in processing any specific transaction. Thus, in this manner, a set of process adapters 802 can be configured such that they can be utilized to process any number and type of transactions.

As described above, transactions between customer 1 10 and merchant 120 can be modeled utilizing transaction messages. More particularly, as described above, transactions between customer 110 and transaction-aggregation system 102 can be modeled utilizing a first-transaction message. Transactions between transaction-aggregation system 102 and merchant 120 can be modeled utilizing a second-transaction message. Utilizing a mapping algorithm, the first-transaction message can be mapped into the second-transaction message through any number of intermediary messages that are internal to transaction-aggregation system 102.

As described above, after receiving a transaction message from user agent 102, transaction engine 204 processes the transaction message internally. More particularly, the transaction message can be mapped into any number of subsequent messages within transaction engine 204. As also described above, in one preferred embodiment, transaction messages are XML messages. As such, in the present embodiment, these XML messages can be converted into JAVA objects. More particularly, as described above, transaction-aggregation system 102 includes XML schemas corresponding to the various XML messages utilized to model transactions. As such, JAVA objects can be generated based on these XML schemas and stored. Thus, when a particular XML message is received, transaction engine 204 can retrieve the appropriate JAVA object corresponding to that XML message. One advantage of converting the XML message into a JAVA object is that the JAVA object can be more quickly accessed than the XML message.

Additionally, as described above, the specific steps associated with performing any particular process can be set forth in process flows. As described above, these process flows can include processes for transforming messages and for utilizing process adapters to perform various tasks, such as interacting with web sites, accessing databases, sending e-mails, and the like. It should be recognized that a process flow can be linked to one or more process flows. As such, a new transaction can be modeled utilizing a set of existing process flows that are linked together. In this manner, a new process flow does not necessarily need to be created from scratch.

Thus far, the present invention has been described in conjunction with a web-based transaction where customer 110 accesses a web site on user agent 202. It should be recognized, however, that the present invention can be utilized in conjunction with various types of e-commerce transactions.

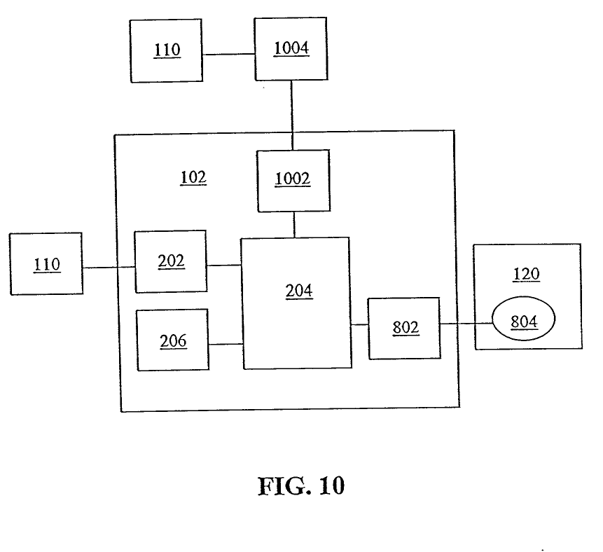

For example, with reference to FIG. 10, transaction-aggregation system 102 includes a connector module 1002 that interfaces with a web-portal 1004. Thus, in this manner, customer 110 can connect with transaction-aggregation system 102 through web-portal 1004 rather than directly through user agent 202.

Additionally, it should be recognized that transaction -aggregation system 102 can be utilized in a non-web-based transactions. For example, transaction aggregation system 102 can be configured to connect to customer 110 and merchant 120 through a TCP/IP connection, a database connection, a direct connection, and the like.

Furthermore, although transaction-aggregation system 102 has been described in conjunction with conducting transactions in e-commerce, it should be recognized that transaction-aggregation system 102 can be configured to facilitate transactions in various applications. For example, customer 110 and merchant 120 can include parties that engage in transacting data and/or information without necessarily engaging in a commercial transaction.

In the description above, various process steps have been described. It should be recognized that each step and combination of steps can be implemented as computer program instructions. It should also be recognized that each step and combination of steps can also be implemented by special purpose hardware-based computer systems that perform the specified functions or steps, or combination of special purpose hardware and computer instructions.

Additionally, although the present invention has been described in conjunction with particular embodiments illustrated in the appended drawing figures, various modifications can be made without departing from the spirit and scope of the invention. Therefore, the present invention should not be construed as limited to the specific form shown in the drawings and described above.

We claim:

1. A transaction aggregation system configured to execute transactions between a customer and a merchant as transaction messages, comprising:
a user agent configured to convert a transaction request received from said customer into a first-transaction message;
a plurality of message schemas;
a repository configured to store said plurality of message schemas; and
a transaction engine configured to:
receive said first-transaction message from said user agent;
map said first-transaction message into a second-transaction message using one of said message schemas stored in said repository; and
transmit said second-transaction message to said merchant, wherein said merchant executes said customer transaction request.

2. The system of claim 1, wherein said transaction aggregation system further comprises:
a process adapter configured to receive said second-transaction message from said transaction engine and translate said second-transaction message to communicate with a plurality of different merchants; and
a connector module for connecting said customer to said transaction engine.

3. The system of claim 1, wherein said customer transaction request comprises a plurality of transaction requests for a plurality of different merchants.

4. The system of claim 3, wherein said transaction engine processes said plurality of transaction requests according to conditions in a process flow.

5. The system of claim 1, wherein said transaction aggregation system facilitates asynchronous communication between said customer and said merchant.

6. The system of claim 1, wherein said customer can disconnect from said user agent after submitting said transaction request to said user agent using a first customer device and reconnect to said user agent using a second customer device to determine the status of said transaction request.

7. The system of claim 3, wherein said transaction engine queues said plurality of transaction messages to be processed a synchronously.

8. The system of claim 1, wherein said transaction engine maps said first transaction message into said second transaction message using schema based mapping, wherein meta-information contained in said schemas are utilized to transform said first transaction message to said second transaction message.

9. The system of claim 2, wherein said process adapter generates and transmits a transaction request status message to said customer.

10. A method for executing transactions between a customer and a merchant using transactions messages, comprising the steps of:
providing a user agent for converting a transaction request received from said customer into a first-transaction message;
storing a plurality of message schemas in a repository
providing a transaction engine for mapping said first-transaction message into a second-transaction message using one of said message schemas stored in said repository;
transmitting said second-transaction message to said merchant, wherein said merchant executes said customer transaction request.

11. The method of claim 10, comprising the additional steps of:
providing a process adapter for translating said second-transaction message to communicate with a plurality of different merchant devices and transmitting a transaction request status message to said customer.

12. The method of claim 10, comprising the additional step of providing a connector module for connecting said customer to said transaction engine.

13. The method of claim 10, wherein said customer transaction request comprises a plurality of transaction requests for a plurality of different merchants.

14. The method of claim 13, wherein said plurality of transactions requests are processed according to conditions in a process flow.

15. The method of claim 10, wherein said customer can disconnect from said user agent after submitting said transaction request to said user agent using a first customer device and reconnect to said user agent using the same customer device or a second customer device to determine the status of said transaction request.

16. The method of claim 13, wherein said transaction engine queues said plurality of transaction messages to be processed asynchronously.

17. The method of claim 10, wherein said transaction engine maps said first transaction message into said second transaction message using schema based mapping, wherein meta-information contained in said schemas are utilized to transform said first transaction message to said second transaction message.

18. A computer-readable storage medium containing computer executable code for implementing a transaction aggregation application by instructing a computer to operate as follows:
execute a user agent for converting a transaction request received from said customer into a first-transaction message;
execute a repository for storing a plurality of message schemas;
execute a transaction engine for mapping said first-transaction message into a second-transaction message by accessing and using one of said message schemas stored in said repository;
transmitting said second-transaction message to said merchant, wherein said merchant executes said customer transaction request.

19. The computer readable storage medium of claim 18, wherein said computer is further instructed to execute a process adapter for translating said second-transaction message to communicate with a plurality of different merchant devices and transmitting a transaction request status message to said customer.

20. The computer readable storage medium of claim 18, wherein said computer is further instructed to execute a connector module for connecting said customer to said transaction engine.

21. The computer readable storage medium of claim 18, wherein said customer transaction request comprises a plurality of transaction requests for a plurality of different merchants.

22. The computer readable storage medium of claim 21, wherein said computer is further instructed to process said plurality of transactions requests according to conditions in a process flow.

23. The computer readable storage medium of claim 18, wherein said customer can disconnect from said user agent after submitting said transaction request to said user agent using a first customer device and reconnect to said user agent using the same customer device or a second customer device to determine the status of said transaction request.

24. The computer readable storage medium of claim 22, wherein said computer is further instructed to execute said transaction engine to queue said plurality of transaction messages to be processed asynchronously.

25. The computer readable storage medium of claim 18, wherein said computer is further instructed to execute said transaction engine to map said first transaction message into said second transaction message using schema based mapping, wherein meta-information contained in said schemas are utilized to transform said first transaction message to said second transaction message.

26. The transaction aggregation system configured to execute transactions between a customer and a merchant as transaction messages, comprising:
a customer transaction request;
a first transaction message;
a second transaction message;
a user agent configured to convert said customer transaction request into said first transaction message;
a plurality of message schemas;
a process flow;
a repository configured to store said plurality of message schemas and said process flow;
a transaction engine configured to:
receive said first-transaction message from said user agent;
map said first-transaction message into said second-transaction message according to said process flow using one of said message schemas stored in said repository; and
transmit said second-transaction message to said merchant, wherein said merchant executes said customer transaction request.

27. The system of claim 26, wherein said transaction aggregation system further comprises:
a process adapter configured to receive said second-transaction message from said transaction engine and translate said second-transaction message to communicate with a plurality of different merchants; and
a connector module for connecting said customer to said transaction engine.

28. The system of claim 26, wherein said customer transaction request comprises a plurality of transaction requests for a plurality of different merchants.

29. The system of claim 26, wherein said transaction aggregation system facilitates asynchronous communication between said customer and said merchant.

30. The system of claim 26, wherein said customer can disconnect from said user agent after submitting said transaction request to said user agent using a first customer device and reconnect to said user agent using a second customer device to determine the status of said transaction request.

31. The system of claim 28, wherein said transaction engine queues said plurality of transaction messages to be processed asynchronously.

32. The system of claim 26, wherein said transaction engine maps said first transaction message into said second transaction message using schema based mapping, wherein meta-information contained in said schemas are utilized to transform said first transaction message to said second transaction message.

33. The system of claim 27, wherein said process adapter generates and transmits a transaction request status message to said customer.
